(19) United States
(12) Patent Application Publication
(10) Pub. No.: US 2025/0191171 A1
(43) Pub. Date: Jun. 12, 2025

(54) SYSTEM AND METHOD OF FINDING PIXEL-TO-DESIGN TARGET FOR DRAM INSPECTION

(71) Applicant: KLA Corporation, Milpitas, CA (US)

(72) Inventors: Jun Jiang, Chapel Hill, NC (US); Tzu-Kuei Lee, Taipei (TW); Huan Jin, Dublin, CA (US); Hucheng Lee, Cupertino, CA (US); Sangbong Park, Danville, CA (US)

(21) Appl. No.: 18/535,159

(22) Filed: Dec. 11, 2023

Related U.S. Application Data
(60) Provisional application No. 63/606,598, filed on Dec. 6, 2023.

(51) Int. Cl. G06T 7/00; G06T 7/12; G06T 7/73

(52) U.S. Cl. CPC G06T 7/0006; G06T 7/001; G06T 7/12; G06T 7/74; G06T 2207/30148

(57) ABSTRACT

A system and method for pixel-to-design alignment for inspection of a dynamic random-access memory wafer are disclosed. The system includes a controller configured to communicate with an inspection sub-system. One or more processors of the controller are configured to receive an input frame from the inspection sub-system, apply a bandpass filter to the input frame to generate a band-passed image, determine a one-dimensional projection profile along a first direction and a second direction of the band-passed image, determine a local range for a portion of the projection profiles, determine a threshold value for the local range which creates two or more distinct regions, identify one or more conjunction locations of two or more non-repeating patterns based on the two or more distinct regions, and obtain a location for one or more pixel-to-design alignment targets based on the one or more conjunction locations.

### CROSS-REFERENCE TO RELATED APPLICATIONS

The present application claims the benefit under 35 U.S.C. § 119(e) of U.S. Provisional Patent Application Ser. No. 63/606,598, filed Dec. 6, 2023, titled “PDA Target Finding for DRAM Wafer”, naming Jun Jiang, Kelvin Lee, Huan Jin, Hucheng Lee, and Sean Park as inventors, which is incorporated herein by reference in the entirety.

### TECHNICAL FIELD

The present disclosure relates generally to semiconductor manufacturing and, more particularly, to a system and method for improving pixel-to-design alignment (PDA) in dynamic random-access memory (DRAM) wafers.

### BACKGROUND

Semiconductor devices, such as dynamic random-access memory DRAM wafers, play an important role in modern electronics. Efficient manufacturing of these devices demands a high degree of precision in the alignment of design elements with the pixel grid of the display. Traditionally, target finding algorithms, such as those based on the Harris Corner detector or image contrast metrics, have been employed to identify key features for pixel-to-design alignment PDA of logic wafers. PDA for logic wafers refers to the process of aligning the physical features observed in the actual image of a semiconductor wafer with the intended design layout. Logic wafers typically have many non-repeating patterns, making them suitable targets for these traditionally used algorithms. However, the unique layout of DRAM wafers presents distinct challenges. DRAM wafers feature large blocks of cells (˜30-50 μm) interspersed with sense amplifier (SA) and sub-word line driver (SWD) repeating patterns, alongside conjunction regions of non-repeating patterns. The existing algorithm, designed with logic wafers in mind, does not account for the intricate layout of the DRAM wafers. Further, recent observations from Samsung escalations highlight limitations in the old Target Finding algorithm when applied to DRAM wafers. The algorithm tends to favor targets biased toward the center of SA, SWD, or conjunction regions. Consequently, the resulting PDA alignment based on these targets often yields inaccurate offsets. These inaccuracies stem from the selected targets lacking high-contrast features and typically exhibiting only one edge, thereby compromising the reliability of the alignment process.

Therefore, it is desirable to provide a method and system that cure the deficiencies of the previous approaches identified above.

### SUMMARY

A method for pixel-to-design alignment for inspection of a dynamic random access memory wafer is disclosed, in accordance with one or more illustrative embodiments of the present disclosure. In one illustrative embodiment, the method includes, but is not limited to receiving an input frame from an inspection sub-system. In another illustrative embodiment, the method includes, but is not limited to, applying a bandpass filter to the input frame to generate a band-passed image. In another illustrative embodiment, the method includes, but is not limited to, calculating a one-dimensional projection profile based on the band-passed image along at least one of a first direction or a second direction. In another illustrative embodiment, the method includes, but is not limited to, calculating a local range for at least a portion of the one-dimensional projection profile along at least one of the first direction or the second direction. In another illustrative embodiment, the method includes, but is not limited to, determining one or more threshold values based on at least one characteristic of the band-passed image along at least one of the first direction or the second direction, wherein the one or more threshold values are configured to segment the local range into two or more distinct regions. In another illustrative embodiment, the method includes, but is not limited to, identifying one or more conjunction locations of two or more non-repeating patterns of the dynamic random access memory wafer based on the one or more distinct regions. In another illustrative embodiment, the method includes, but is not limited to, obtaining a location for one or more pixel-to-design alignment targets based on the identified one or more conjunction locations.

A system for pixel-to-design alignment for inspection of a dynamic random access memory wafer is disclosed, in accordance with one or more illustrative embodiments of the present disclosure. In one illustrative embodiment, the system includes a controller. In another illustrative embodiment, the controller includes one or more processors configured to execute program instructions stored in memory. In another illustrative embodiment, the program instructions are configured to cause the one or more processors to receive an input frame from the inspection sub-system. In another illustrative embodiment, the program instructions are configured to cause the one or more processors to apply a bandpass filter to the input frame to generate a band-passed image. In another illustrative embodiment, the program instructions are configured to cause the one or more processors to calculate a one-dimensional projection profile based on the band-passed image along at least one of a first direction or a second direction. In another illustrative embodiment, the program instructions are configured to cause the one or more processors to calculate a local range for at least a portion of the one-dimensional projection profile along at least one of the first direction or the second direction. In another illustrative embodiment, the program instructions are configured to cause the one or more processors to determine one or more threshold values based on at least one characteristic of the band-passed image along at least one of the first direction or the second direction, wherein the one or more threshold values are configured to segment the local range into two or more distinct regions. In another illustrative embodiment, the program instructions are configured to cause the one or more processors to identify one or more conjunction locations of two or more non-repeating patterns of the dynamic random access memory wafer based on the one or more distinct regions. In another illustrative embodiment, the program instructions are configured to cause the one or more processors to obtain a location for one or more pixel-to-design alignment targets based on the identified one or more conjunction locations.

A system for pixel-to-design alignment for inspection of a dynamic random access memory wafer is disclosed, in accordance with one or more illustrative embodiments of the present disclosure. In one illustrative embodiment, the system includes an inspection sub-system. In one illustrative embodiment, the inspection sub-system includes an illumination source configured to generate illumination directed toward the dynamic random access memory wafer, wherein the illumination interacts with a surface of the dynamic random access memory wafer. In another illustrative embodiment, the inspection sub-system includes a detector configured to detect the illumination reflected from a surface of the dynamic random access memory wafer. In another illustrative embodiment, the system includes a controller. In another illustrative embodiment, the controller includes one or more processors configured to execute program instructions stored in memory. In another illustrative embodiment, the program instructions are configured to cause the one or more processors to receive an input frame from the inspection sub-system. In another illustrative embodiment, the program instructions are configured to cause the one or more processors to apply a bandpass filter to the input frame to generate a band-passed image. In another illustrative embodiment, the program instructions are configured to cause the one or more processors to calculate a one-dimensional projection profile based on the band-passed image along at least one of a first direction or a second direction. In another illustrative embodiment, the program instructions are configured to cause the one or more processors to calculate a local range for at least a portion of the one-dimensional projection profile along at least one of the first direction or the second direction. In another illustrative embodiment, the program instructions are configured to cause the one or more processors to determine one or more threshold values based on at least one characteristic of the band-passed image along at least one of the first direction or the second direction, wherein the one or more threshold values are configured to segment the local range into two or more distinct regions. In another illustrative embodiment, the program instructions are configured to cause the one or more processors to identify one or more conjunction locations of two or more non-repeating patterns of the dynamic random access memory wafer based on the one or more distinct regions. In another illustrative embodiment, the program instructions are configured to cause the one or more processors to obtain a location for one or more pixel-to-design alignment targets based on the identified one or more conjunction locations.

It is to be understood that both the foregoing general description and the following detailed description are exemplary and explanatory only and are not necessarily restrictive of the invention as claimed. The accompanying drawings, which are incorporated in and constitute a part of the specification, illustrative embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A illustrates a conceptual view of a DRAM wafer with traditional PDA targets, in accordance with one or more embodiments of the present disclosure.

FIG. 1B illustrates a conceptual view of the DRAM wafer with PDA targets centered around one or more conjunctions, in accordance with one or more embodiments of the present disclosure.

FIG. 2A illustrate a conceptual view of a system for finding one or more PDA targets for inspection of the DRAM wafer, in accordance with one or more embodiments of the present disclosure.

FIG. 2B illustrates a simplified block diagram view of a system for finding one or more PDA targets, in accordance with one or more embodiments of the present disclosure.

FIG. 3 illustrates a process flow diagram depicting a method for finding a PDA target for inspection of the DRAM wafer, in accordance with one or more embodiments of the present disclosure.

FIG. 4A illustrates a conceptual view of an input frame of the DRAM wafer, in accordance with one or more embodiments of the present disclosure.

FIG. 4B illustrates a conceptual view of a band-passed image of a DRAM wafer, in accordance with one or more embodiments of the present disclosure.

FIG. 4C illustrates a normalized one-dimensional projection profile of the band-passed image along a first direction and a second direction of the DRAM wafer, in accordance with one or more embodiments of the present disclosure.

FIG. 4D illustrates application of a sliding window to the normalized one-dimensional projection profile, in accordance with one or more embodiments of the present disclosure.

FIG. 4E illustrates a local range of the normalized one-dimensional projection profile within the sliding window, in accordance with one or more embodiments of the present disclosure.

FIG. 4F illustrates one or more regions exceeding a threshold value of the local range, in accordance with one or more embodiments of the present disclosure.

FIG. 4G illustrates a determination of a midpoint of the one or more regions exceeding the threshold value of the local range, in accordance with one or more embodiments of the present disclosure.

FIG. 4H illustrates one or more conjunction locations derived from the one or more regions exceeding the threshold value of the local range, in accordance with one or more embodiments of the present disclosure.

FIG. 4I illustrates one or more PDA targets obtained based on the one or more conjunction locations, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

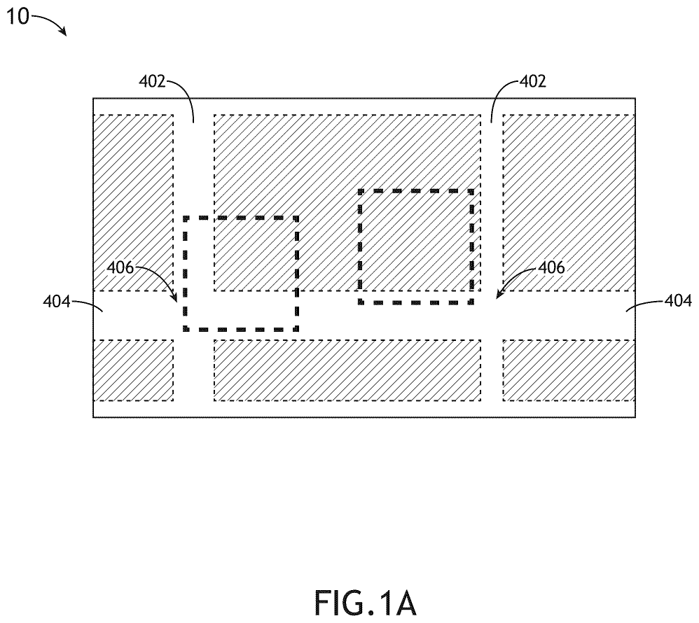

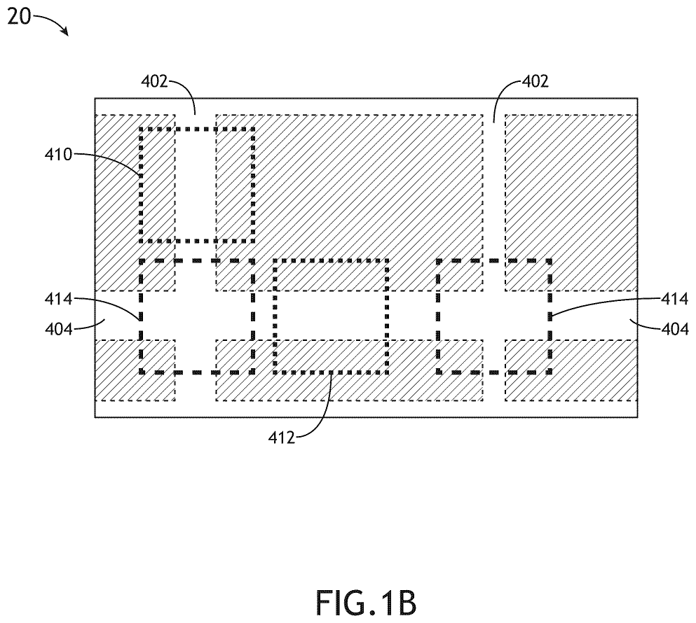

Embodiments of the present disclosure are directed to a system and method for finding PDA targets for inspection of DRAM wafers. Traditionally, PDA targets were identified using methods such as the Harris Corner detector or image contrast metrics. FIG. 1A illustrates this conventional approach, where high-contrast corners, indicative of the junctions of edges of non-repeating patterns, were selected as targets. However, this method, primarily designed for logic wafers with non-repeating patterns, faced challenges in addressing the unique layout complexities of DRAM wafers.

DRAM wafers have distinct layouts characterized by large blocks of cells separated by regions of non-repeating patterns such as, but not limited to, SA and SWD. The limitations of traditional PDA target finding can be seen in FIG. 1A. For example, the PDA targets may exhibit a bias towards the center of the SA, SWD, or conjunction regions resulting in inaccurate offsets during PDA alignment. The traditional PDA target finding system and method is disclosed in U.S. Pat. No. 11,803,960 and issued on Oct. 31, 2023, which is incorporated herein by reference in its entirety.

To overcome these challenges, a system and method for target finding for DRAM wafers is disclosed, as depicted in FIG. 1B. Embodiments are directed to identifying PDA targets that (i) encompass the entire conjunction region; (ii) cover the two cell boundaries between the SA and the cell; and (iii) cover the two cell boundaries between SWD and the cell. Additionally, this approach may reject targets covering only one edge of the cell boundary between the SA and/or SWD and the cell. Instead, targets may be centered around the repeating patterns (e.g., SA and SWD) and the non-repeating patterns (e.g., conjunction regions of the SA and SWD. This approach ensures that PDA targets may include two symmetric edges of the non-repeating patterns, providing more reliable alignment.

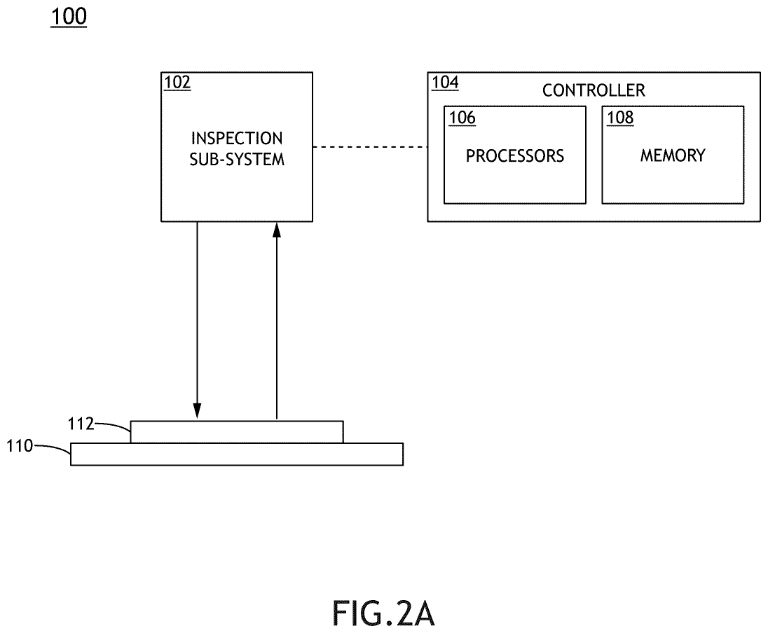

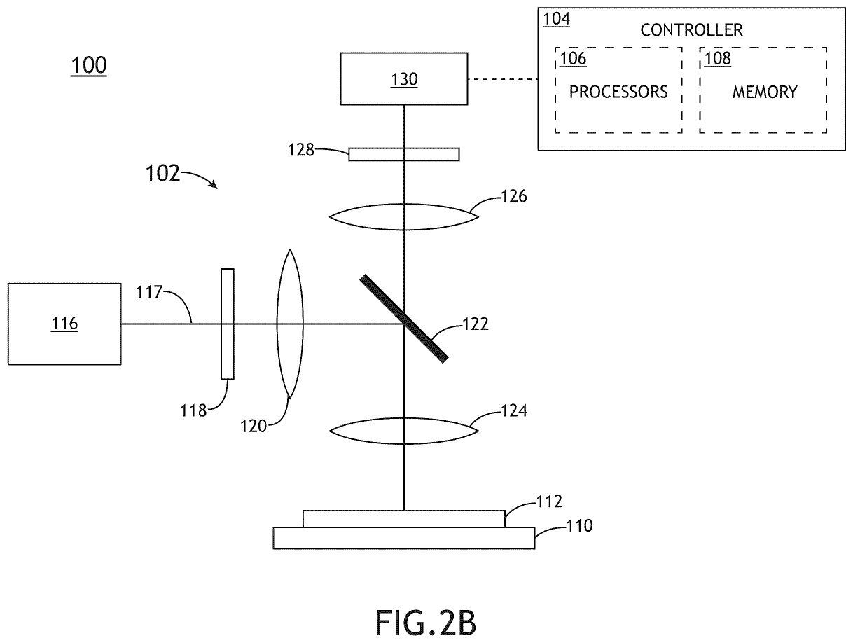

FIG. 2A illustrates a simplified block diagram of a system 100 for identifying a PDA target for inspection of a DRAM wafer, in accordance with one or more embodiments of the present disclosure. In embodiments, the system 100 includes inspection sub-system 102 configured to inspect a semiconductor (e.g., DRAM) wafer 112 disposed on a sample stage 110 and a controller 104 communicatively coupled to the inspection sub-system. The controller 104 may include one or more processors 106 and a memory 108.

In embodiments, the one or more processors 106 of the controller 104 are configured to receive an input frame 400 from the inspection sub-system 102. For example, the input frame 400 may correspond to a die on the wafer 112.

In embodiments, the one or more processors 106 are configured to apply a bandpass filter to the input frame 400 to generate a band-passed image 401. The bandpass filter may be configured to modify the frequency content of the input frame to highlight or suppress specific spatial frequencies. For example, the bandpass filter may enhance the visibility of relevant features by suppressing low-frequency components (e.g., background variations) and high-frequency noise.

In embodiments, the one or more processors 106 determine a one-dimensional projection profile based on the band-passed image 401 along a first and second direction. For example, the one or more processors 106 may be configured to analyze intensity variations in the band-passed image, translating them into a simplified one-dimensional representation along the first and second directions. It is noted herein that the one-dimensional projection profiles may be normalized to ensure consistency and allow for comparison across different images.

In embodiments, the one or more processors 106 determine a local range of the one-dimensional projection profile along the first and second directions. For example, the local range may be determined by one or more processors 106 configured to analyze a variation in the intensity values within a sliding window 410 of the one-dimensional projection profiles.

In embodiments, the one or more processors 106 apply a threshold value to the local ranges. For example, the one or more processors 106 may determine a threshold value through an analysis of the variation in intensity of the local range, aiming to identify an intensity threshold that segments the local range into two or more distinct regions.

In embodiments, the one or more processors 106 identify a region of the local range values that exceeds the threshold value along the first and second direction, indicating a location of a PDA repeating pattern (e.g., SA or SWD). For example, the terminal points of the region may exceed the threshold value indicate changes in the underlying pattern. By way of another example the terminal points of the region may indicate and align with the edges of repeating patterns such as, but not limited to, SA or SWD.

In embodiments, the one or more processors 106 are configured to identify one or more conjunction locations of non-repeating patterns based on the identified regions exceeding the threshold value. For example, the one or more processors 106 may be configured to use the starting and ending points of the distinct regions along both the x-direction and the y-direction to determine the intersection point of two non-repeating patterns (e.g., the intersection of the SA and SWD).

In embodiments, the one or more processors 106 are configured to obtain a location of at least one PDA target based on the identified conjunction locations. For example, the one or more processors 106 may be configured to use the identified conjunction locations as reference points to guide the identification and localization of one or more PDA targets (e.g., SA target and SWD target).

In embodiments, the one or more processors 106 are configured to generate one or more care areas based on the one or more identified PDA targets. For example, the one or more care areas may represent one or more areas of the wafer that further inspection/review by the inspection sub-system 202 or other review tool is desired. In embodiments, the inspection/review tool (e.g., broadband plasma tool) inspect/review the care area with increased scrutiny to identify defects within the care area. Following the additional inspection and review facilitated by the care areas, the controller 104 may initiate one or more feedback or feedforward steps. For example, the controller 104 may transmit control signals to one or more process tools (e.g., lithography tool) on the fabrication line. Care area generation is disclosed in U.S. Pat. No. 11,113,827 issued on Sep. 7, 2021 and U.S. Pat. No. 10,692,690 issued on Jun. 23, 2020, both of which are incorporated herein by reference in their entirety.

FIG. 2B illustrates a simplified block diagram view of the system 100 for finding one or more PDA targets, in accordance with one or more embodiment of the present disclosure. The inspection sub-system 102 may include any appropriate inspection sub-system (e.g., a broadband plasma inspection sub-system) or tool known in the art, such as, but not limited to, an optical inspection tool (e.g., broadband plasma inspection tool) or an electron beam inspection tool. For example, in the case of an optical inspection, the inspection tool may include, but is not limited to, a bright-field inspection tool, or a dark-field inspection tool.

In embodiments, the inspection sub-system 102 includes an illumination source 116, a detector 130 and various optical components for performing inspection. The illumination source 116 may include any illumination source (e.g., a broadband plasma light source) known in the art. For example, the illumination source 116 may include a narrow band light source (e.g., laser) or a broadband source (e.g., broadband plasma source). In embodiments, the illumination source 116 is configured to direct light 117 to a surface of the wafer 112 (via various optical components) disposed on the sample stage 110 via an illumination pathway. For example, the illumination pathway may include one or more illumination-pathway focusing elements 120, a beam splitter 122, or additional illumination-pathway optical components 118 suitable for modifying and/or conditioning the light 117. The inspection tool may include an objective lens 124 to focus or otherwise direct the light 117 onto the sample 112. Further, the various optical components of the inspection tool may be configured to direct light reflected and/or scattered from the surface of an inspected region of the wafer 112 to the detector 130 of the inspection sub-system 102.

The detector 130 may include any appropriate detector known in the art. For example, the detector 130 may include a CCD detector, a TDI-CCD detector, or a PMT detector. The detector 130 may be used to detect defects on the wafer 112 through a collection pathway. For example, the detector 130 may receive an image of the wafer 112 provided by one or more optical elements in the collection pathway (e.g., the objective lens 124, one or more collection-pathway focusing elements 126, or the like). The collection pathway may further include any number of collection-pathway optical elements 128 to direct and/or modify illumination collected by the objective lens 124 including, but not limited to, one or more filters, one or more polarizers, or one or more beam blocks.

In embodiments, the detector 130 is communicatively coupled to the controller 104. In this regard, the controller 104 may be configured to detect defects on wafer 112 using detection data collected and transmitted by the detector 130. The controller 104 may utilize any method and/or algorithm known in the art to detect defects on the wafer 112.

Further, the controller 104 may be coupled to the detector 130 in any suitable manner (e.g., by one or more transmission media indicated by the dotted line shown in FIGS. 2A through 2B) such that the controller 104 can receive the output generated by the detector 130.

In embodiments, the inspection sub-system 102 is configured to accept instructions from another sub-system of the system 100. For instance, the inspection sub-system 102 may accept instructions from the controller 104 (or analyzer) of system 100. Upon receiving the instructions from the controller 104, the inspection sub-system 102 may perform an inspection process at one or more locations of the semiconductor wafer 112 identified in the provided instructions (i.e., the inspection recipe).

In embodiments, the controller 104 is configured to receive and/or acquire data or information from other systems (e.g., inspection results from an inspection system or metrology results from a metrology system) by a transmission medium including wireline and/or wireless portions. In this manner, the transmission medium may serve as a data link between the one or more controllers 104 and other sub-systems of the system 100. Moreover, the one or more controllers 104 may send data to external systems via a transmission medium (e.g., network connection).

The one or more processors 106 of controller 104 may include any one or more processing elements known in the art. In this sense, the one or more processors 106 may include any microprocessor-type device configured to execute software algorithms and/or instructions. In embodiments, the one or more processors 106 are embodied in a desktop computer, mainframe computer system, workstation, image computer, parallel processor, or other computer system (e.g., networked computer) configured to execute a program configured to operate the system 100, as described throughout the present disclosure. It should be recognized that the steps described throughout the present disclosure may be carried out by a single computer system or, alternatively, multiple computer systems. In general, the term “processor” is broadly defined to encompass any device having one or more processing elements, which may execute program instructions from a non-transitory memory medium 108. Moreover, different sub-systems of the system 100 may include a processor or logic elements suitable for carrying out at least a portion of the steps described throughout the present disclosure. Therefore, the above description should not be interpreted as a limitation on the present invention but merely an illustration.

The memory medium 108 may include any storage medium known in the art suitable for storing program instructions executable by the associated one or more processors 106. For example, the memory medium 108 may include, but is not limited to, a read-only memory, a random-access memory, a magnetic or optical memory device (e.g., disk), a magnetic tape, a solid-state drive and the like. In embodiments, it is noted herein that the memory 108 is configured to store one or more results from the inspection sub-system 102 and/or the output of the various steps described herein. It is further noted that memory 108 may be housed in a common controller housing with the one or more processors 106. In an alternative embodiment, the memory 108 is located remotely with respect to the physical location of the processors 106 and controller 104. For instance, the one or more processors 106 of controller 104 may access a remote memory (e.g., server), accessible through a network (e.g., internet, intranet and the like).

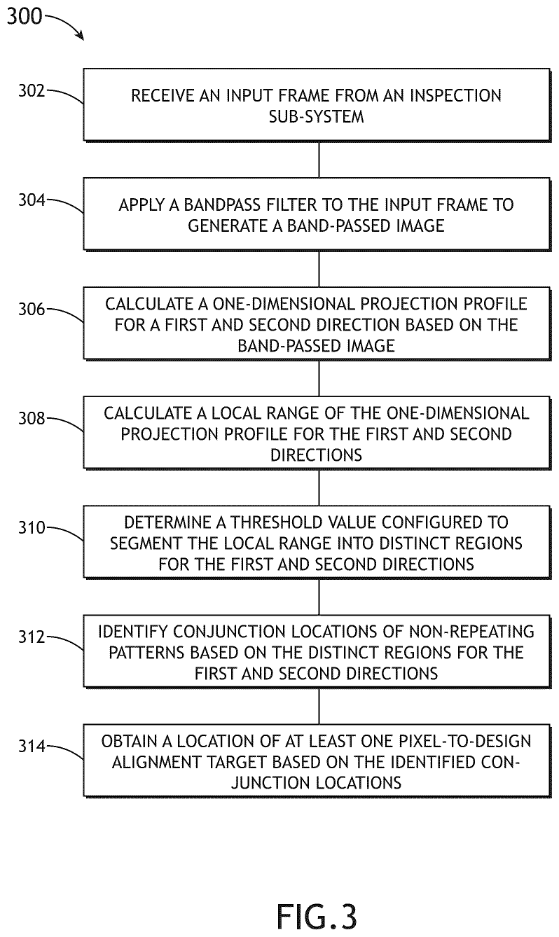

FIG. 3 illustrates a process flow diagram depicting a method 300 for pixel-to-design alignment (PDA) for inspection of a dynamic random-access memory (DRAM) wafer, in accordance with one or more embodiments of the present disclosure. Applicant notes that the embodiments and enabling technologies described previously herein in the context of the system 100 should be interpreted to extend to the method 300. It is further noted, however, that the method 300 is not limited to the architecture of the system 100.

In embodiments, the method 300 includes a step 302 of receiving an input frame 400 from an inspection sub-system 102. For example, the input frame 400 may be received by the controller 104 from the inspection sub-system 102. By way of another example, the input frame 400 may be stored in memory 108, which is accessed later for analysis of the input frame 400.

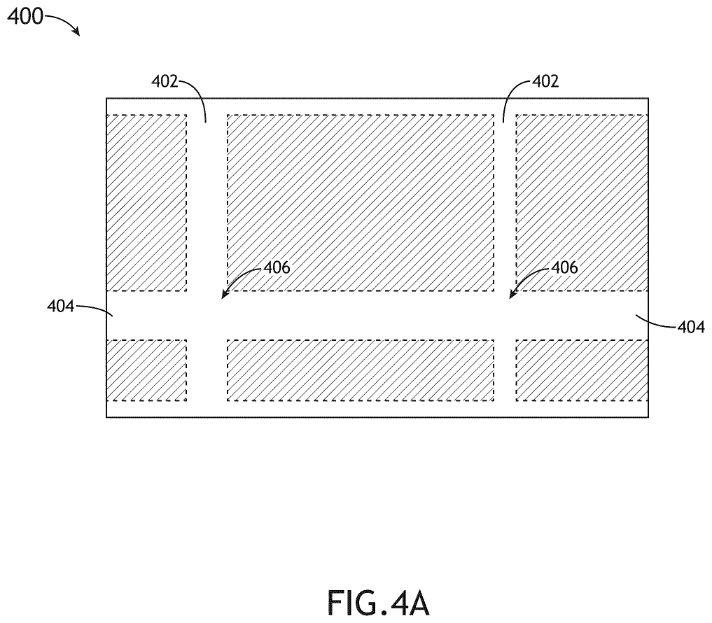

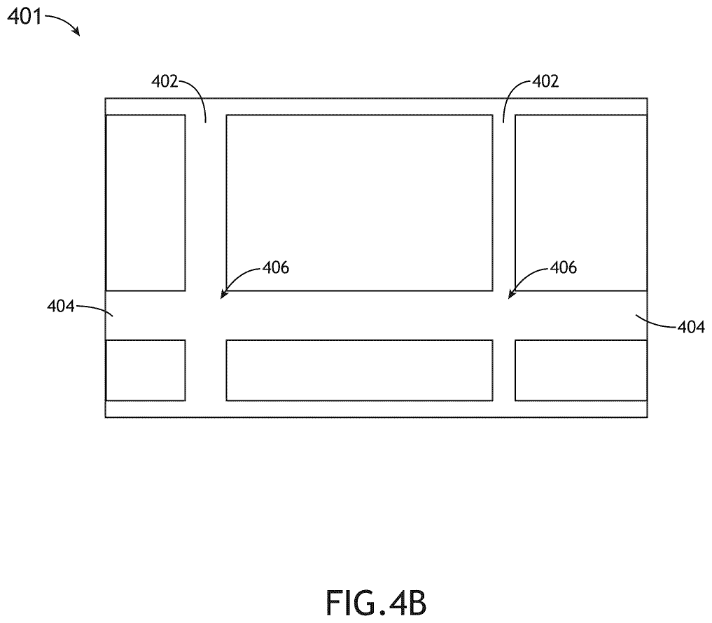

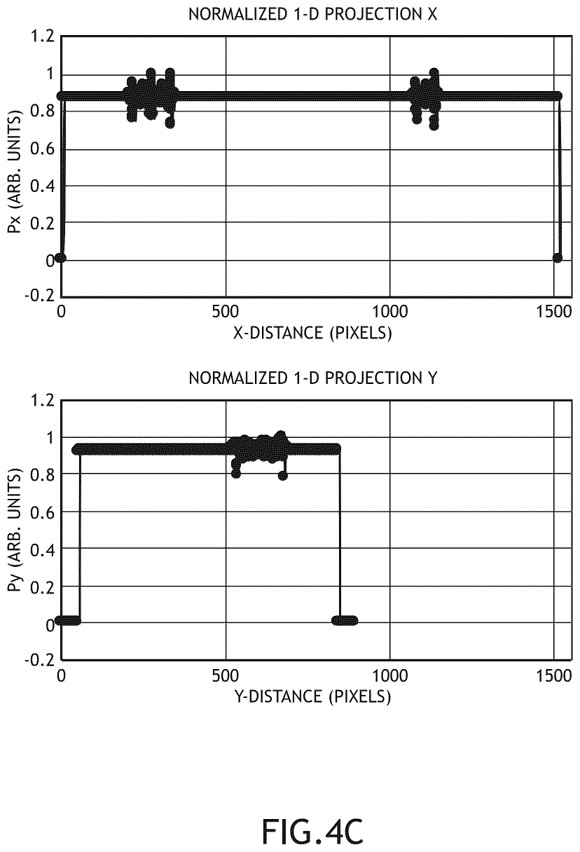

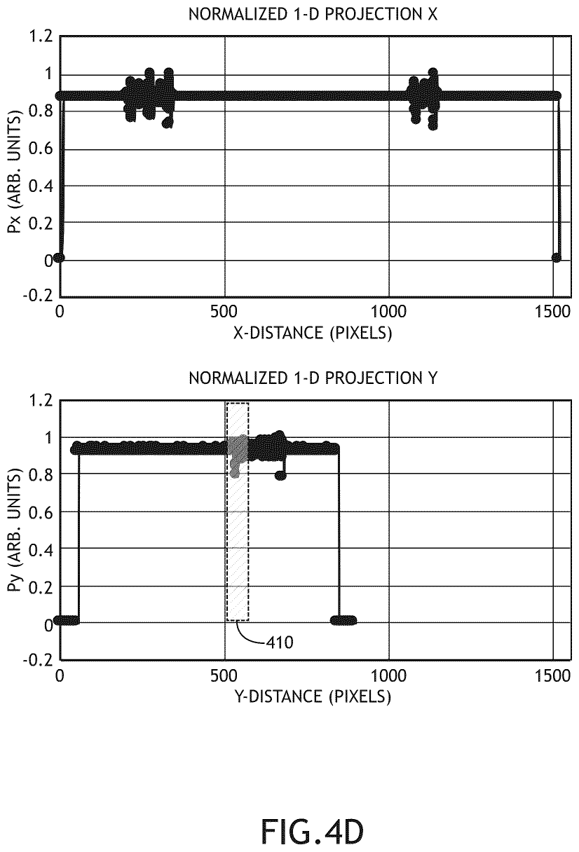

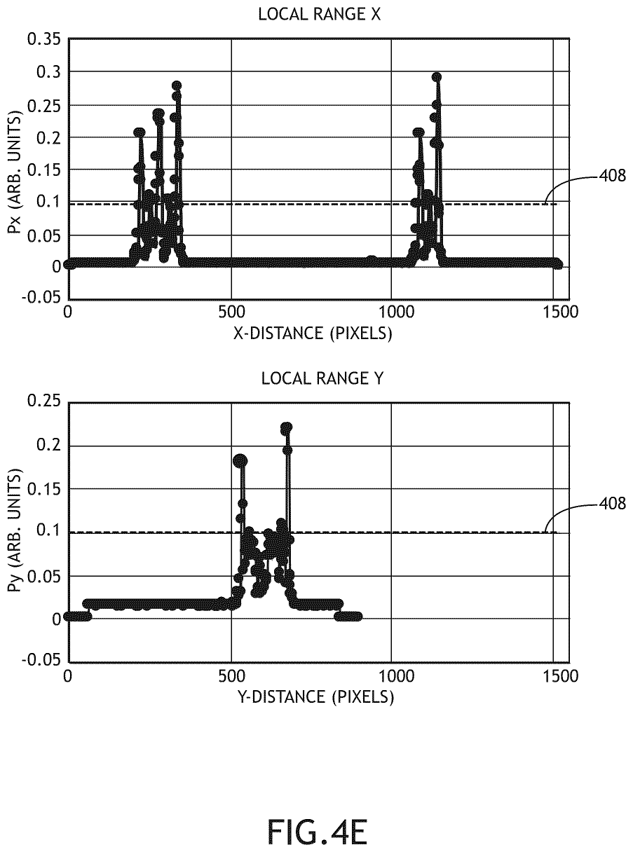

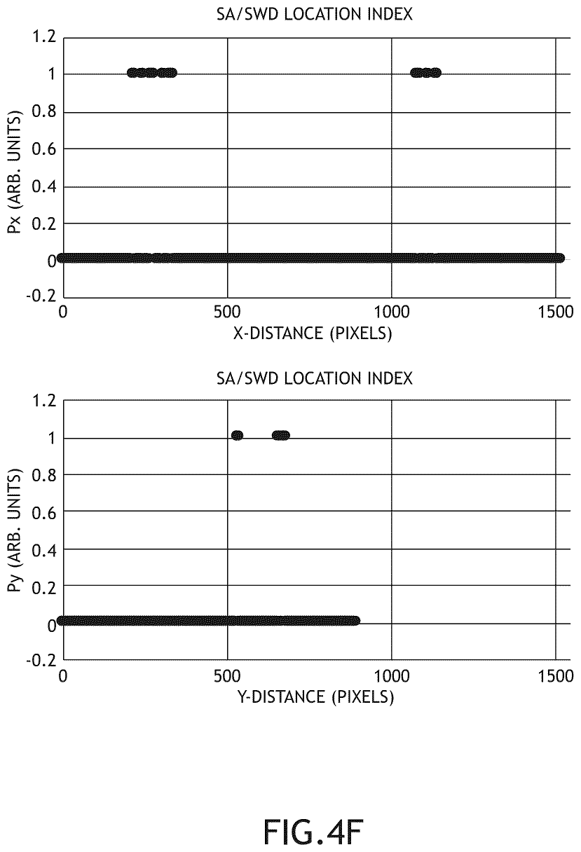

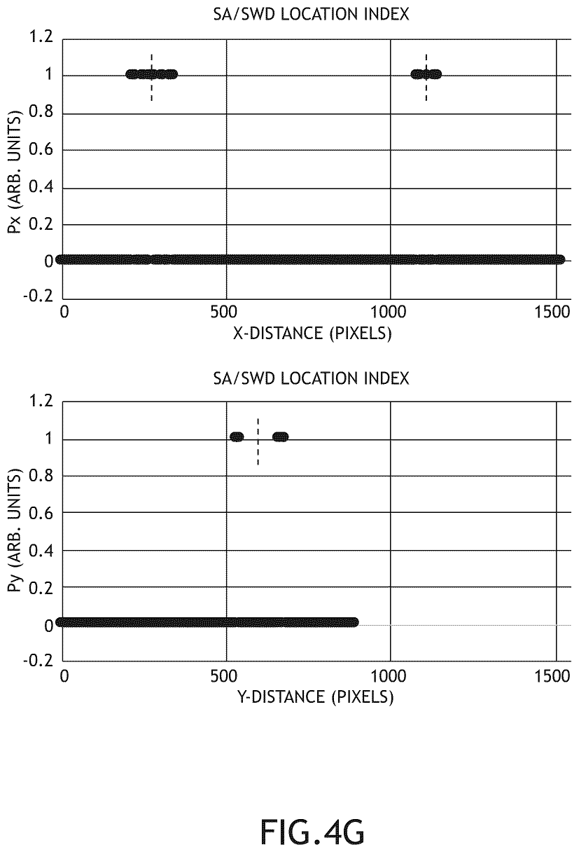

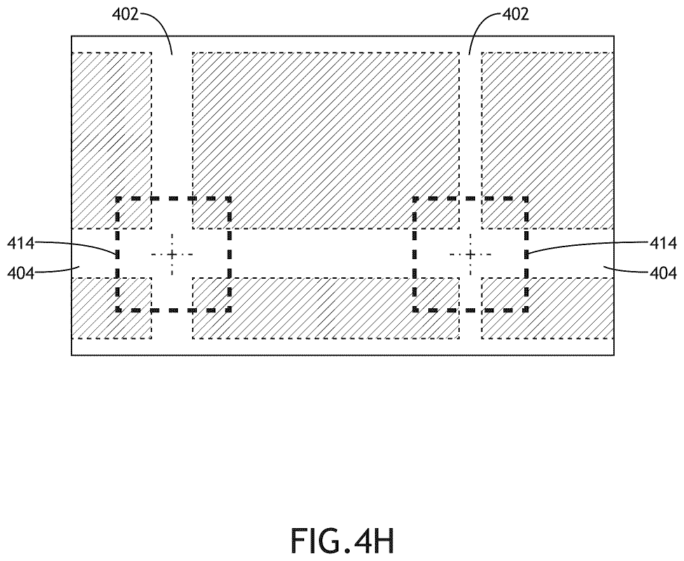

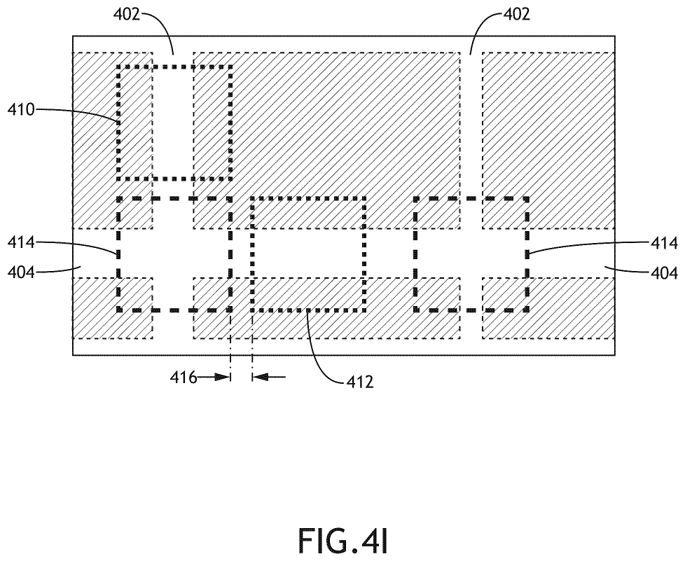

In embodiments, the received input frame 400 includes a set of characteristics and features, as shown in FIG. 4A. For example, the input frame may include an arrangement of memory cells forming a distinct repeating pattern across the DRAM wafer. By way of another example, the input frame may include components such as, but not limited to, one or more SWD 402 and SA 404. By way of another example, the input frame may include conjunction regions 406, where the different features intersect. The conjunction regions 406 may serve as reference points for PDA.

In embodiments, the method 300 includes a step 304 of applying a bandpass filter to the input frame 400 to generate a band-passed image 401. For example, the one or more processors 106 may be configured to apply the bandpass filter, which modifies the frequency content of the input frame to highlight or suppress specific spatial frequencies, as shown in FIG. 4B. By way of another example, the bandpass filter may enhance the visibility of relevant features by suppressing low-frequency components (e.g., background variations) and high-frequency noise.

In embodiments, the method 300 includes a step 306 of calculating a one-dimensional projection profile for a first and second direction, based on the band-passed image. For example, the one or more processors 106 may be configured to analyze intensity variations in the band-passed image, translating them into a simplified one-dimensional representation for each of the first and second directions, as shown in FIG. 4C. The equations for performing the one-dimensional projection profile calculations may be defined as follows:

$${P}_{x} ( x ) = {\sum }_{y} {I}_{bp} ( x , y ) / max [ {\sum }_{y} {I}_{bp} ( x , y ) ] \qquad ( 1 )$$

$${P}_{y} ( y ) = {\sum }_{x} {I}_{bp} ( x , y ) / max [ {\sum }_{x} {I}_{bp} ( x , y ) ] \qquad ( 2 )$$

where Pₓ(x) represents the one-dimensional projection profile along the x-direction, where P_{y}(y) represents the one-dimensional projection profile along the y-direction, where Σ_{y}I_{bp}(x, y) represents the summation of intensity values along the y-direction for a given x, where ΣₓI_{bp}(x, y) represents the summation of intensity values along the x-direction for a given y, where max[Σ_{y}I_{bp}(x, y)] represents the maximum value among the summation of intensity values along the y-direction for all x, and where max[ΣₓI_{bp}(x, y)] represents the maximum value among the summation of intensity values along the x-direction for all y.

In embodiments, the calculated one-dimensional projection profiles are normalized to ensure consistency and allow for comparison across different images.

In embodiments, the method 300 includes a step 308 of calculating a local range of the one-dimensional projection profile for the first and second directions. For example, the local range may be calculated by one or more processors 106 configured to analyze the variation in intensity values within a sliding window 410 of the one-dimensional projection profiles, as shown in FIG. 4D. By way of another example, the sliding window 410 may be configured as a predetermined pixel width (e.g., 9 pixels). The equation for performing the local range calculations may be defined as follows:

$${LR}_{x} ( u ) = {max}_{x ∈ [ u , u + w ]} {P}_{x} ( x ) - {min}_{x ∈ [ u , u + w ]} {P}_{x} ( x ) \qquad ( 3 )$$

where LRₓ(u) represents the local range of the one-dimensional profile along the x-direction within a specified window, where u represents the starting position or index of the window along the x-axis, where w represents the width or size of the window used for local range calculation, where

$${max}_{x ∈ [ u , u + w ]} {P}_{x} ( x )$$

represents the maximum intensity within the specified window of the one-dimensional projection profile along the x-direction, and where

$${min}_{x ∈ [ u , u + w ]} {P}_{x} ( x )$$

represents the minimum intensity within the specified window of the one-dimensional projection profile along the x-direction.

It is noted herein that equation 3 may be adapted to calculate the local range along the y-direction as well. For instance, the variables and indices may be adjusted to reflect the calculations along the y-axis as opposed to the x-axis.

In embodiments, the method 300 includes a step 310 of determining a threshold value of the local range along the first and second directions. For example, the threshold value 408 may be determined by the one or more processors 106 configured to segment the calculated local range into two or more distinct regions along both the first and second directions, as shown in FIG. 4E. By way of another example, the one or more processors 106 may determine the threshold value through an analysis of the local range variations, aiming to identify an intensity threshold that segments the local range into two or more distinct regions.

In embodiments, as shown in FIG. 4F, a region of the local range values that exceed the threshold value indicate a location of a PDA non-repeating pattern (e.g., sense amplifier (SA) or sub-word line driver (SWD)). For example, the terminal points of the distinct region that exceed the threshold value may indicate changes in the underlying pattern. In the context of DRAM wafers, these transitions may align with the edges of non-repeating patterns such as, but not limited to, SA or SWD.

In embodiments, the method 300 includes a step 312 of identifying one or more conjunction locations of non-repeating patterns based on the distinct regions for the first and second directions. For example, as shown in FIG. 4G-4H, the one or more processors 106 may be configured to use the starting and ending points of the distinct regions along both the x-direction and the y-direction to determine the intersection point of two non-repeating patterns (e.g., the intersection of the SA and SWD).

In embodiments, the method 300 includes a step 314 of obtaining a location of at least one pixel-to design alignment target based on the identified conjunction locations. For example, as shown in FIG. 4I, the one or more processors 106 may be configured to use the identified conjunction locations as reference points to guide the identification and localization of one or more PDA alignment targets (e.g., SA target and SWD target).

In embodiments, the method 300 includes an additional step of defining one or more care areas based on a relationship between a pattern of the one or more identified PDA alignment targets and a source pattern. For example, the one or more processors 106 may be configured to utilize an offset obtained during the alignment process to determine the one or more care areas.

In embodiments, the one or more processors 106 are configured to generate one or more care areas based on the one or more identified PDA targets. For example, the one or more care areas may represent one or more areas of the wafer (or die on the wafer) that is desired to be inspected by the inspection sub-system 202 or other review tool. By way of another example, the one or more processors 106 may communicate the one or more care areas to the inspection sub-system 202 to be used for identifying PDA targets. The one or more care areas may be configured to aid the BBP inspection tool in identifying defects during the inspection process. Following the additional inspection and review facilitated by the care areas, the controller 104 may initiate a series of feedback and feedforward steps. These steps may involve sending precise control instructions not only to the BBP inspection tool but also to one or more process tools on the fabrication line.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

As used throughout the present disclosure, the term “sample” generally refers to a substrate formed of a semiconductor or non-semiconductor material (e.g., a wafer, or the like). For example, a semiconductor or non-semiconductor material includes, but is not limited to, monocrystalline silicon, gallium arsenide, and indium phosphide.

It is believed that the present disclosure and many of its attendant advantages will be understood by the foregoing description, and it will be apparent that various changes may be made in the form, construction, and arrangement of the components without departing from the disclosed subject matter or without sacrificing all its material advantages. The form described is merely explanatory, and it is the intention of the following claims to encompass and include such changes. Furthermore, it is to be understood that the invention is defined by the appended claims.

What is claimed:

1. A method for pixel-to-design alignment for inspection of a dynamic random access memory wafer, the method comprising:
receiving an input frame from an inspection sub-system;
applying a bandpass filter to the input frame to generate a band-passed image;
calculating a one-dimensional projection profile based on the band-passed image along at least one of a first direction or a second direction;
calculating a local range for at least a portion of the one-dimensional projection profile along at least one of the first direction or the second direction;
determining one or more threshold values based on at least one characteristic of the band-passed image along at least one of the first direction or the second direction, wherein the one or more threshold values are configured to segment the local range into two or more distinct regions;
identifying one or more conjunction locations of two or more non-repeating patterns based on the two or more distinct regions; and
obtaining a location for one or more pixel-to-design alignment targets based on the one or more conjunction locations.

2. The method of claim 1, further comprising: determining one or more care areas based on the one or more pixel-to-design alignment targets, wherein the one or more care areas represent one or more regions of interest of the dynamic random access memory wafer.

3. The method of claim 1, wherein calculating the local range comprises subtracting a maximum intensity value from a minimum intensity value within a window of the one-dimensional projection profile, wherein the window is defined by a predetermined pixel width along at least one of the first direction or the second direction.

4. The method of claim 1, wherein a region of the two or more distinct regions exceeding the one or more threshold values indicates a position of at least one of a sense amplifier or a sub-word line driver.

5. The method of claim 4, wherein the one or more conjunction locations are defined as an intersection point of the sense amplifier and the sub-word line driver.

6. The method of claim 4, wherein one of the one or more pixel-to-design alignment targets is configured to cover a first cell boundary and a second cell boundary between the sense amplifier and a cell.

7. The method of claim 4, wherein one of the one or more pixel-to-design alignment targets is configured to cover a first cell boundary and a second cell boundary between the sub-word line driver and a cell.

8. The method of claim 4, wherein one of the one or more pixel-to-design alignment targets is rejected when only a single cell boundary is covered between at least one of the sense amplifier or the sub-word line driver and a cell.

9. The method of claim 1, wherein one of the one or more pixel-to-design alignment targets is configured to cover one of the one or more conjunction locations of the dynamic random access memory wafer in its entirety.

10. The method of claim 1, wherein obtaining one of the one or more pixel-to-design alignment targets comprises determining one or more symmetric edges around the one or more conjunction locations.

11. The method of claim 1, wherein the first direction comprises an x-direction and the second direction comprises a y-direction perpendicular to the x-direction.

12. A system for pixel-to-design alignment for inspection of a dynamic random access memory wafer, comprising:
an inspection sub-system comprising:
an illumination source configured to generate illumination directed toward the dynamic random access memory wafer, wherein the illumination interacts with a surface of the dynamic random access memory wafer; and
a detector configured to detect the illumination reflected from the surface of the dynamic random access memory wafer; and
a controller comprising one or more processors configured to execute program instructions stored in memory, wherein the program instructions are configured to cause the one or more processors to:
receive an input frame from the inspection sub-system;
apply a bandpass filter to the input frame to generate a band-passed image;
calculate a one-dimensional projection profile based on the band-passed image along at least one of a first direction or a second direction;
calculate a local range for at least a portion of the one-dimensional projection profile along at least one of the first direction or the second direction;
determine one or more threshold values based on at least one characteristic of the band-passed image along at least one of the first direction or the second direction, wherein the one or more threshold values are configured to segment the local range into two or more distinct regions;
identify one or more conjunction locations of two or more non-repeating patterns based on the two or more distinct regions; and
obtain a location for one or more pixel-to-design alignment targets based on the one or more conjunction locations.

13. The system of claim 12, wherein the inspection sub-system comprises a broadband plasma inspection sub-system and the illumination source comprises a broadband plasma light source.

14. The system of claim 12, wherein the one or more processors are further configured to determine one or more care areas based on the one or more pixel-to-design alignment targets, wherein the one or more care areas represent one or more regions of interest of the dynamic random access memory wafer.

15. The system of claim 12, wherein calculating the local range comprises subtracting a maximum intensity value from a minimum intensity value within a window of the one-dimensional projection profile, wherein the window is defined by a predetermined pixel width along at least one of the first direction or the second direction.

16. The system of claim 12, wherein a region of the two or more distinct regions exceeding the one or more threshold values indicates a position of at least one of a sense amplifier or a sub-word line driver.

17. The system of claim 16, wherein the one or more conjunction locations are defined as an intersection point of the sense amplifier and the sub-word line driver.

18. The system of claim 16, wherein one of the one or more pixel-to-design alignment targets is configured to cover a first cell boundary and a second cell boundary between the sense amplifier and a cell.

19. The system of claim 16, wherein one of the one or more pixel-to-design alignment targets is configured to cover a first cell boundary and a second cell boundary between the sub-word line driver and a cell.

20. The system of claim 16, wherein one of the one or more pixel-to-design alignment targets is rejected when only a single cell boundary is covered between at least one of the sense amplifier or the sub-word line driver and a cell.

21. The system of claim 12, wherein one of the one or more pixel-to-design alignment targets is configured to cover one of the one or more conjunction locations of the dynamic random access memory wafer in its entirety.

22. The system of claim 12, wherein obtaining one of the one or more pixel-to-design alignment targets comprises determining one or more symmetric edges around the one or more conjunction locations.

23. The system of claim 12, wherein the first direction comprises an x-direction and the second direction comprises a y-direction perpendicular to the x-direction.

24. A system for pixel-to-design alignment for inspection of a dynamic random access memory wafer comprising:
a controller comprising one or more processors configured to execute program instructions stored in memory, wherein the program instructions are configured to cause the one or more processors to:
receive an input frame from an inspection sub-system;
apply a bandpass filter to the input frame to generate a band-passed image;
calculate a one-dimensional projection profile based on the band-passed image along at least one of a first direction or a second direction;
calculate a local range for at least a portion of the one-dimensional projection profile along at least one of the first direction or the second direction;
determine one or more threshold values based on at least one characteristic of the band-passed image along at least one of the first direction or the second direction, wherein the one or more threshold values are configured to segment the local range into two or more distinct regions;
identify one or more conjunction locations of two or more non-repeating patterns based on the two or more distinct regions; and
obtain a location for one or more pixel-to-design alignment targets based on the one or more conjunction locations.

25. The system of claim 24, wherein the one or more processors are further configured to determine one or more care areas based on the one or more pixel-to-design alignment targets, wherein the one or more care areas represent one or more regions of interest of the dynamic random access memory wafer.

26. The system of claim 24, wherein calculating the local range comprises subtracting a maximum intensity value from a minimum intensity value within a window of the one-dimensional projection profile, wherein the window is defined by a predetermined pixel width along at least one of the first direction or the second direction.

27. The system of claim 24, wherein a region of the two or more distinct regions exceeding the one or more threshold values indicates a position of at least one of a sense amplifier or a sub-word line driver.

28. The system of claim 27, wherein the one or more conjunction locations are defined as an intersection point of the sense amplifier and the sub-word line driver.

29. The system of claim 27, wherein one of the one or more pixel-to-design alignment targets is configured to cover a first cell boundary and a second cell boundary between the sense amplifier and a cell.

30. The system of claim 27, wherein one of the one or more pixel-to-design alignment targets is configured to cover a first cell boundary and a second cell boundary between the sub-word line driver and a cell.

31. The system of claim 27, wherein one of the one or more pixel-to-design alignment targets is rejected when only a single cell boundary is covered between at least one of the sense amplifier or the sub-word line driver and a cell.

32. The system of claim 24, wherein one of the one or more pixel-to-design alignment targets is configured to cover one of the one or more conjunction locations of the dynamic random access memory wafer in its entirety.

33. The system of claim 24, wherein obtaining one of the one or more pixel-to-design alignment targets comprises determining one or more symmetric edges around the one or more conjunction locations.

34. The system of claim 24, wherein the first direction comprises an x-direction and the second direction comprises a y-direction perpendicular to the x-direction.
